(19) United States
(12) Patent Application Publication
(10) Pub. No.: US 2006/0219854 A1
(43) Pub. Date: Oct. 5, 2006

(54) Gauge bracket assembly

(75) Inventors: Frank Sardina, Waukesha, WI (US); Todd W. Wilson, Milwaukee, WI (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company Group, Inc., Milwaukee, WI (US)

(21) Appl. No.: 11/075,243

(22) Filed: Mar. 8, 2005

(51) Int. Cl. F16M 11/00

(52) U.S. Cl. 248/230.1

(57) ABSTRACT

A gauge bracket assembly coupled to a motorcycle having handlebars. The gauge bracket assembly including an upper handlebar clamp and a gauge bracket. The upper handlebar clamp is coupled to the motorcycle to at least partially secure the handlebars to the motorcycle. The handlebar clamp includes a first connection interface. The gauge bracket includes at least one mounting section for mounting gauges and a second connection interface. The first connection interface includes one of a protruding portion and a receiving portion, and the second connection interface includes the other of the protruding portion and the receiving portion. The first connection interface is coupled to the second connection interface such that the protruding portion is received within the receiving portion.

### FIELD OF THE INVENTION

The present invention relates to gauge bracket assemblies, and more specifically to motorcycle gauge bracket assemblies with modular gauge brackets.

### BACKGROUND OF THE INVENTION

Many designs and methods exist for connecting a gauge bracket to a handlebar clamp of a motorcycle. Many gauge brackets are formed integrally with the upper clamp of the handlebar clamp to extend above the handlebars to be viewed by the motorcycle operator.

In some designs, the gauge bracket is a separate component from the upper clamp and is attachable to a planar interface of the upper clamp through the use of fasteners. The separation of the gauge bracket and the upper clamp allows for the interchangeability of different gauge brackets for simplified customization of a motorcycle. However, the interface between the gauge bracket and the upper clamp is significantly less robust than using an integrally-formed assembly.

### SUMMARY OF THE INVENTION

One embodiment of the present invention is directed to a gauge bracket assembly coupled to a motorcycle having handlebars. The gauge bracket assembly including an upper handlebar clamp and a gauge bracket. The upper handlebar clamp is coupled to the motorcycle to at least partially secure the handlebars to the motorcycle. The upper handlebar clamp includes a first connection interface. The gauge bracket includes at least one mounting section for mounting gauges and a second connection interface. The first connection interface includes one of a protruding portion and a receiving portion, and the second connection interface includes the other of the protruding portion and the receiving portion. The first connection interface is coupled to the second connection interface such that the protruding portion is received within the receiving portion.

Another embodiment of the present invention is a gauge bracket for a motorcycle having handlebars and an upper handlebar clamp coupled to the motorcycle to at least partially secure the handlebars to the motorcycle. The upper handlebar clamp includes a first connection interface having one of a protruding portion and a receiving portion. The gauge bracket including at least one mounting section for mounting gauges and a second connection interface. The second connection interface includes the other of the protruding portion and the receiving portion. The second connection interface is adapted to be coupled to the first connection interface such that the protruding portion is received within the receiving portion.

More information and a better understanding of the present invention can be achieved by referring to the following drawings and detailed description.

### BRIEF DESCRIPTION OF THE DRAWINGS

FIG. 1 is a side view of motorcycle including a gauge bracket assembly embodying the present invention.

FIG. 2 is an enlarged view of the gauge bracket assembly shown in FIG. 1.

FIG. 3 is a front exploded view of the gauge bracket assembly shown in FIG. 1.

FIG. 4 is a rear exploded view of the gauge bracket assembly shown in FIG. 1.

FIG. 5 is a cross-section view taken along line 5-5 in FIG. 3.

FIG. 6 is a rear perspective view of the gauge bracket assembly shown in FIG. 1.

FIGS. 7-14 illustrate gauge brackets of gauge bracket assemblies according to other embodiments of the invention.

FIGS. 15-20 illustrate upper handlebar clamps of gauge bracket assemblies according to other embodiments of the invention.

### DETAILED DESCRIPTION

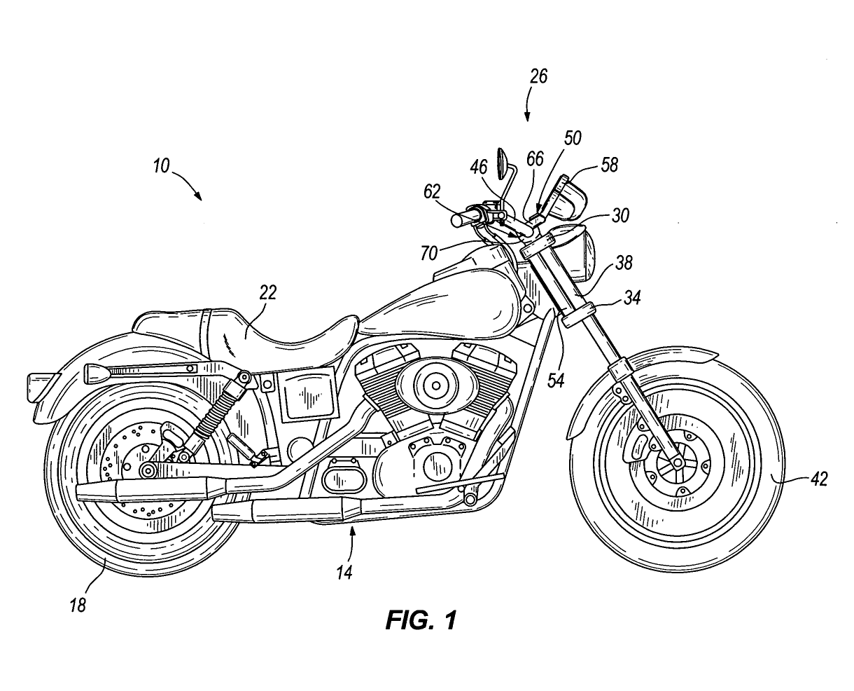

FIG. 1 illustrates a motorcycle 10 including a frame 14, a rear wheel 18 rotatably coupled to the frame 14, a seat 22 positioned above the rear wheel 18, and a steering assembly 26 that is rotatably coupled to the frame 14. The steering assembly 26 includes an upper triple clamp 30, a lower triple clamp 34, and a pair of fork tubes 38 extending through and secured within aligned openings in both triple clamps 30, 34. A front wheel 42 is rotatably coupled to the lower end of the fork tubes 38. The steering assembly 26 also includes a handlebar 46 and a gauge bracket assembly 50 securing the handlebar 46 to the upper triple clamp 30. A motorcycle operator maneuvers the handlebars 46 in order to steer the motorcycle 10. As a driver turns the handlebars 46, the steering assembly 26 rotates relative to a neck 54 of the frame 14.

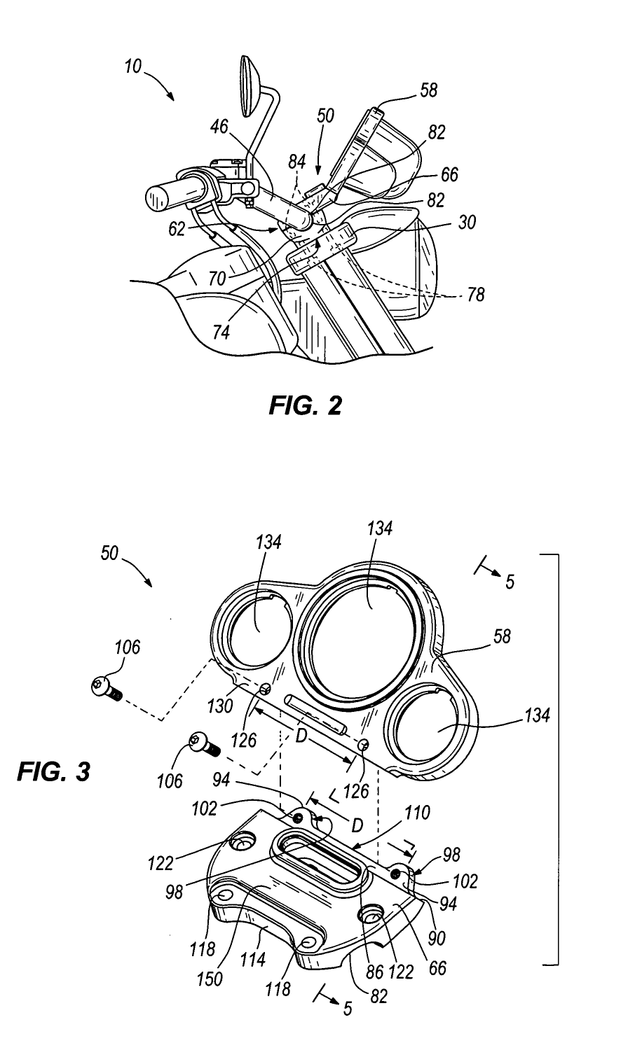

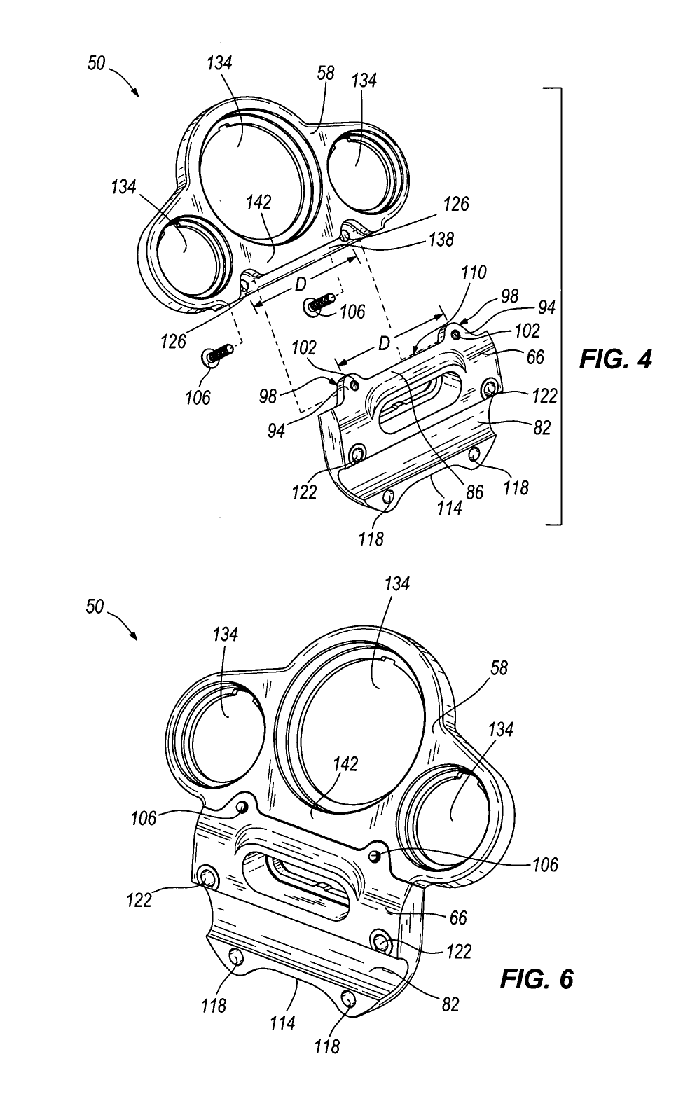

As shown in FIGS. 2 and 3, the gauge bracket assembly 50 includes a gauge bracket 58 and an upper handlebar clamp 66. The upper handlebar clamp 66 is coupled to a lower handlebar clamp 70 to define a handlebar clamp 62. The lower handlebar clamp 70 of the gauge bracket assembly 50 is coupled to a top surface 74 of the upper triple clamp 30 through the use of fasteners 78, such as bolts. As illustrated in FIGS. 2 and 3, the upper handlebar clamp 66 and the lower handlebar clamp 70 have respective recesses 82 to receive a portion of the handlebars 46. The recesses 82 in this embodiment have the shape of a half cylinder, together forming a cylindrically-shaped recess positioned to receive cylindrically shaped handlebars 46. Conventional fasteners 84, such as bolts, can be inserted into the upper handlebar clamp 66 to couple the upper handlebar clamp 66 to the lower handlebar clamp 70.

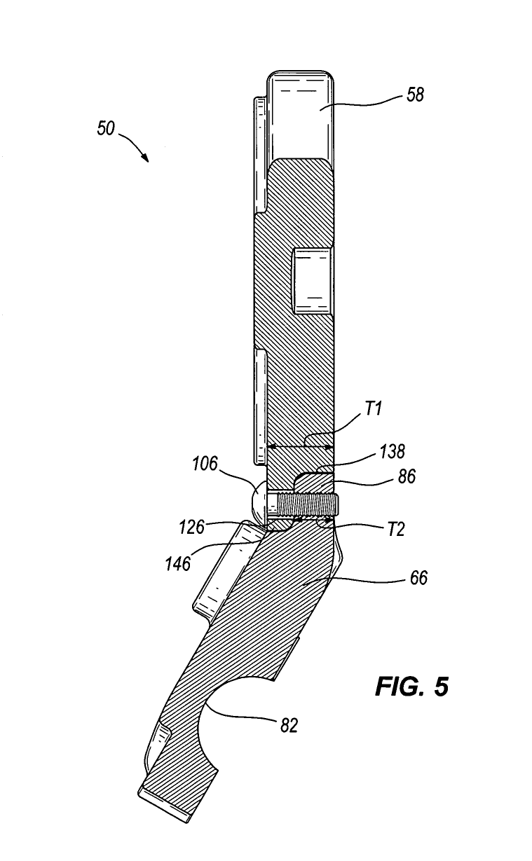

As illustrated in FIG. 3, the upper handlebar clamp 66 includes a first connecting section, or protruding portion 86, extending from a flat surface 90. The protruding portion 86 has two bosses 94. Each boss 94 is located on a respective end of the protruding portion 86 and includes a generally rounded top portion 98. With further reference to FIG. 4, apertures 102 extend through each respective boss 94 to receive fasteners 106 for connection to the gauge bracket 58. The apertures 102 are threaded and are located a distance D apart. The protruding portion 86 also includes a flange 110 extending between the two bosses 94.

In addition to the connecting section 86, the upper handlebar clamp 66 further includes a mounting section 114 having two apertures 118. An additional, lower gauge bracket (not shown) can be connected to the mounting section 114 of the upper handlebar clamp 66. Additional apertures 122 are located on the upper handlebar clamp 66 and are used in combination with apertures 118 for mounting the upper handlebar clamp 66 to the lower handlebar clamp 70 (shown in FIG. 2). The fasteners 84 (shown in phantom in FIG. 2) extend through the upper handlebar clamp 70 and into the lower handlebar clamp 70.

As shown in FIG. 4, the gauge bracket 58 of the gauge bracket assembly 50 also has two apertures 126 for receiving fasteners 106. The fasteners 106 can be entered through a front face 130 (shown in FIG. 3) of the gauge bracket 58. The apertures 126 of the gauge bracket 58 are also separated by the distance D. The illustrated gauge bracket 58 has three mounting sections 134 for gauges (not shown). The gauges can be coupled to the mounting sections 134 through a variety of means, such as threaded connections, snap-on fittings, or conventional fasteners.

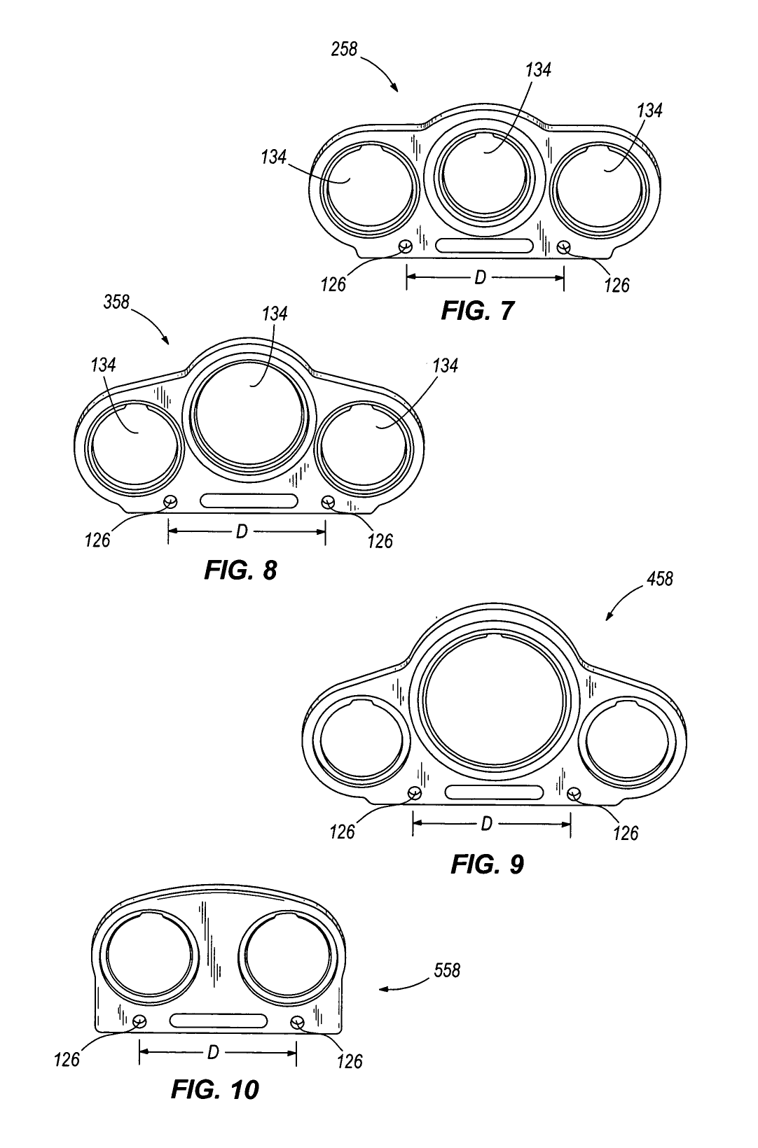

As shown in FIGS. 4 and 5, the gauge bracket 58 has a receiving portion, or recess 138 that extends partially through a thickness T1 of the gauge bracket 58. The recess 138 has the same thickness T2 as the protruding portion 86. Also, the recess 138 has a substantially similar mirror-image shape as the protruding portion 86. The protruding portion 86 is flush with a back surface 142 (shown in FIG. 4) of the gauge bracket 58.

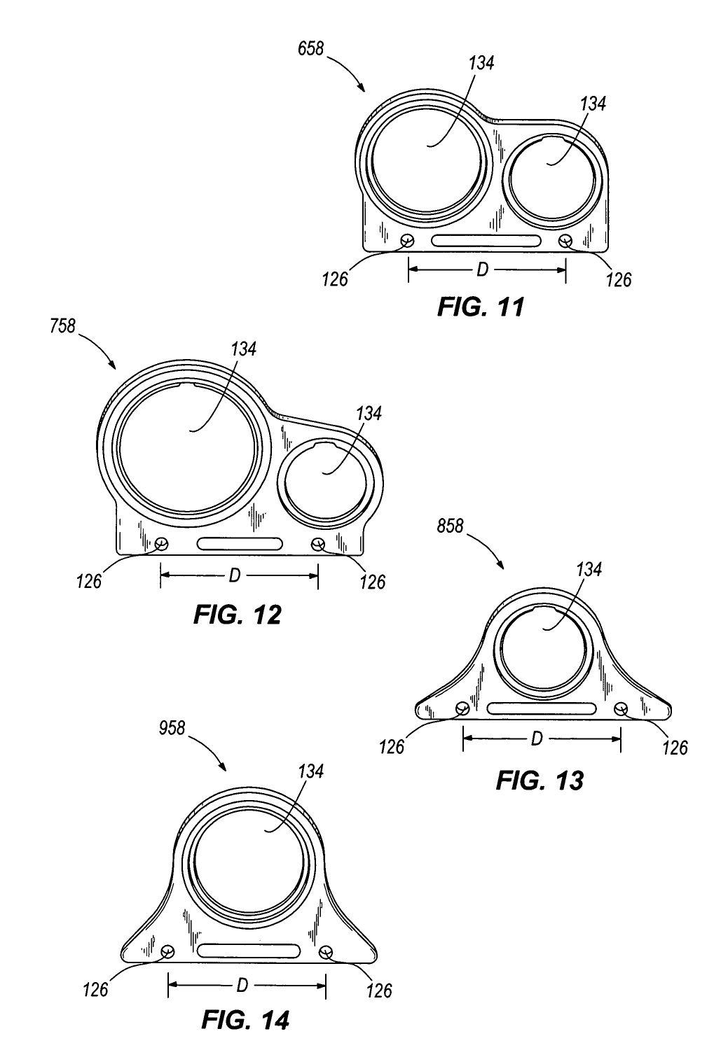

As illustrated in FIGS. 5 and 6, the protruding portion 86 is received within and mates with the recess 138. The upper handlebar clamp 66 can thereby be coupled to the gauge bracket 58 by the fasteners 106 extending through apertures 102, 126 that are aligned together. Mating surfaces (shown in FIG. 5) create a flush connection between the gauge bracket 58 and upper handlebar clamp 66. In the illustrated embodiment, the fastener 106 extends through the upper handlebar clamp 66 and the gauge bracket 58 to couple the gauge bracket 58 and the upper handlebar clamp 66. The protruding portion 86 of the upper handlebar clamp 66 is located to the rear of a portion 146 of the gauge bracket 58. In alternate embodiments, the recess 138 can be in the middle of the thickness T1 of the gauge bracket 58, or the recess 138 can be located at the front surface 130 of the gauge bracket 58, thereby causing the protruding portion 86 to be in the middle of the flat surface 90 of the upper handlebar clamp 66 or flush with a front surface 150 of the upper handlebar clamp 66, respectively.

The mating of the protruding portion 86 with the recess 138 provides additional support for the joints between the gauge bracket 58 and the upper handlebar clamp 66. The shape of the protruding portion 86 of the upper handlebar clamp 66 and the corresponding recess 138 of the gauge bracket 58 can have slight variations.

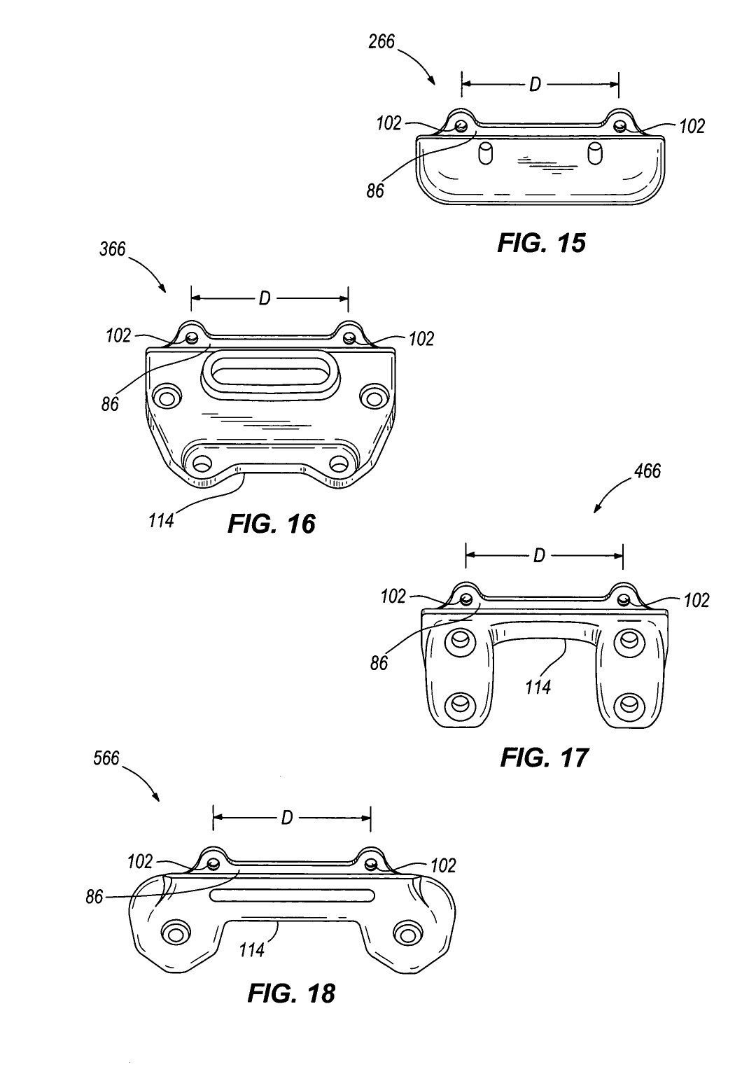

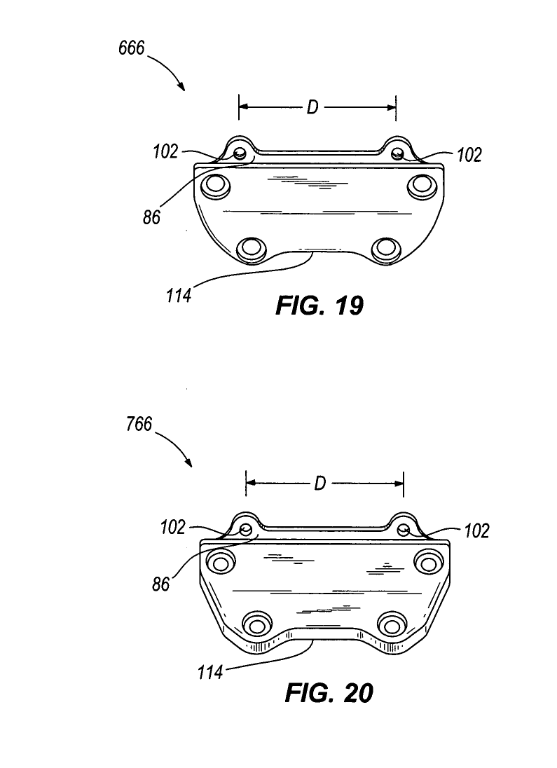

The distance D between apertures 102 and apertures 126 can be constant for different styles of upper handlebar clamps and gauge brackets, respectively. Additionally, the shape of the protruding portion 86 and the corresponding recess 138 can be constant for the different styles so that a series of differently-shaped gauge brackets (as shown in FIGS. 7-14) can fit a series of differently-shaped upper handlebar clamps (as shown in FIGS. 15-20). For example, eight embodiments of the gauge bracket 258, 358, 458, 558, 658, 758, 858, 958 are shown and six embodiments of the upper handlebar clamp 266, 366, 466, 566, 666, 766 are shown. By interchanging the gauge brackets 58, 258, 358, 458, 558, 658, 758, 858, 958 and upper handlebar clamps 266, 366, 466, 566, 666, 766, forty-eight combinations of gauge bracket assemblies 14 can be made.

FIGS. 7-14 show alternate embodiments of the gauge bracket 58 of the gauge bracket assembly 50. The gauge brackets 258, 358, 458, 558, 658, 758, 858, 958 shown can support one, two, or three gauges, corresponding to the number of mounting sections 134 present. The embodiments of the gauge bracket 258, 358, 458, 558, 658, 758, 858, 958 are a representative sample of the gauge brackets 58 that can be made. More or less mounting sections 134 can be present as well as other shapes and sizes of gauge brackets 58 to allow for increased customization of the motorcycle 10. Although the recess 138 is not shown in FIGS. 7-14, the recess on the embodiments of the gauge bracket 258, 358, 458, 558, 658, 758, 858, 958 is similar to the recess shown in the embodiment of the gauge bracket 58 shown in FIGS. 1-6.

FIGS. 15-20 show alternate embodiments of the upper handlebar clamp 66 of the gauge bracket assembly 10. The embodiments of the upper handlebar clamp 266, 366, 466, 566, 666, 766 are a representative sample of the upper handlebar clamps 66 that can be made. Other shapes and sizes of upper handlebar clamps 66 can also be used to allow for increased customization of the motorcycle 10. The protruding portion 86 shown in FIGS. 15-20 for upper handlebar clamps 266, 366, 466, 566, 666, 766 is the same as the protruding portion 86 of the embodiment of the upper handlebar clamp 66 shown in FIGS. 1-6.

The constructions and aspects described above and illustrated in the drawings are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the claims.

We claim:

1. A gauge bracket assembly adapted to be coupled to a motorcycle having handlebars, the gauge bracket assembly comprising:
an upper handlebar clamp adapted to be coupled to the motorcycle to at least partially secure the handlebars to the motorcycle, the upper handlebar clamp including a first connection interface; and
a gauge bracket with at least one mounting section for mounting gauges, the gauge bracket having a second connection interface, wherein the first connection interface includes one of a protruding portion and a receiving portion, and the second connection interface includes the other of the protruding portion and the receiving portion, the first connection interface coupled to the second connection interface such that the protruding portion is received within the receiving portion.

2. The gauge bracket assembly of claim 1, wherein the protruding portion further comprises two bosses at opposite ends of the protruding portion.

3. The gauge bracket assembly of claim 2, wherein the protruding portion includes a flange connecting the two bosses.

4. The gauge bracket assembly of claim 3, wherein the bosses of the protruding portion have a thickness that is greater than a thickness of the flange.

5. The gauge bracket assembly of claim 2, wherein each of the bosses includes an aperture.

6. The gauge bracket assembly of claim 5, wherein the gauge bracket includes apertures aligning with the apertures of the bosses when the protruding portion is received within and mates with the receiving portion.

7. The gauge bracket assembly of claim 6, wherein the bosses are threaded.

8. The gauge bracket assembly of claim 1, wherein the upper handlebar clamp includes the protruding portion and the gauge bracket includes the receiving portion.

9. The gauge bracket assembly of claim 1, wherein the protruding portion includes a rear surface and the gauge bracket includes a rear surface, the rear surfaces being substantially within the same plane when the protruding portion is received within and mates with the receiving portion.

10. A gauge bracket for a motorcycle including handlebars and an upper handlebar clamp coupled to the motorcycle to at least partially secure the handlebars to the motorcycle, the upper handlebar clamp including a first connection interface, the first connection interface including one of a protruding portion and a receiving portion, the gauge bracket comprising:
at least one mounting section for mounting gauges; and
a second connection interface, wherein the second connection interface includes the other of the protruding portion and the receiving portion, the second connection interface adapted to be coupled to the first connection interface such that the protruding portion is received within the receiving portion.

11. The gauge bracket of claim 10, wherein the protruding portion further comprises two bosses at opposite ends of the protruding portion.

12. The gauge bracket of claim 11, wherein the protruding portion includes a flange connecting the two bosses.

13. The gauge bracket of claim 12, wherein the bosses of the protruding portion have a thickness that is greater than a thickness of the flange.

14. The gauge bracket of claim 11, wherein each of the bosses includes an aperture.

15. The gauge bracket of claim 14, further comprising apertures aligning with the apertures of the bosses when the protruding portion is received within and mates with the receiving portion.

16. The gauge bracket of claim 15, wherein the bosses are threaded.

17. The gauge bracket of claim 10, wherein the upper handlebar clamp includes the protruding portion and the gauge bracket includes the receiving portion.

18. The gauge bracket of claim 10, wherein the protruding portion includes a rear surface and the gauge bracket includes a rear surface, the rear surfaces being substantially within the same plane when the protruding portion is received within and mates with the receiving portion.
